(19) United States
(12) Patent Application Publication
(10) Pub. No.: US 2014/0280467 A1
(43) Pub. Date: Sep. 18, 2014

(54) METHOD OF MANAGING PORT DHCP SERVER PROTOCOL ADDRESSES

(71) Applicant: EVERFOCUS ELECTRONICS CORP., New Taipei City (TW)

(72) Inventor: Chia-Ming HUANG, New Taipei City (TW)

(73) Assignee: EverFocus Electronics Corp., New Taipei City (TW)

(21) Appl. No.: 13/801,045

(22) Filed: Mar. 13, 2013

(51) Int. Cl. H04L 29/12

(52) U.S. Cl. CPC H04L 61/2015
USPC 709/203

(57) ABSTRACT

A method of managing port DHCP server protocol addresses is provided, applicable to switch hub. The port DHCP server connects to at least a port and includes port IP address allocation table. When the port try to connect, port DHCP is given priority to receive DHCP discovery message broadcast from port and respond to client. The client can use the default IP address provided by port DHCP server, instead of waiting for floating IP address provided by other DHCP server. When the hardware connected to port is replaced or reset, the hardware automatically obtains default IP address of port. When the port is connected to more than one device with IP, the method allows first device to obtain default IP address of port and other devices automatically obtains floating IP address provided by other DHCP server to shorten waiting time and provide convenient management of each port connection.

### BACKGROUND OF THE INVENTION

1. Field of the Invention

The present invention relates to a method of managing port DHCP server protocol addresses, and more particularly to a method of using port DHCP server to respond to the client with a DHCP offer message including default IP address so as to reduce the connection waiting time and improve efficiency of managing each port connection, applicable to hub, switch hub, router, IP sharing device, or other similar devices.

2. Description of Related Art

The network devices that are currently available in the market, such as network camera, can use a static IP address that is manually set in advance or a non-static IP address. The non-static IP device is required to obtain a floating IP address from a DHCP server of an ISP provider or a self-set DHCP server, where the DHCP is a “dynamic host configuration protocol”. Therefore, both the DHCP server of ISP provider or the self-set DHCP server must meet the RFC 1541 standard or RFC 2131 standard to connect to the Internet.

The aforementioned DHCP server will perform poorly when experiencing a sudden burst of traffic flow (such as after a power outage), because all the clients may send a DHCP request to the DHCP server to obtain new IP address after being set offline caused by the power outage. When receiving the DHCP requests, the DHCP server must inquire the database so that the DHCP server is unable to rapidly issue IP addresses to the client requests. Eventually, when the waiting DHCP requests accumulate, the response speed slows down even further.

In addition, when the client issues broadcast DHCP discovery message to the network, a plurality of DHCP servers may exist in the network and each of these DHCP servers may supply the client with a floating IP address and other configuration settings.

According to the RFC 1541 or RFC 2131 standard, the client can only accept the first DHCP offer message including IP address regardless of the origin of the DHCP offer message. Therefore, the configuration of the port regarding the corresponding IP address is non-static, which leads to management difficulty. For example, an Internet camera can obtain an IP address in three ways. The first is that the Internet camera is preset with a default initial virtual static IP address; the second is that the Internet camera obtains a floating IP address from a DHCP server through the DHCP technique; and the third is that the Internet camera obtains a static IP address or a floating IP address from an ISP provider through the point-to-point protocol over Ethernet (PPPoE). Regardless of the technique, when the Internet camera and the control terminal device have IP addresses do not belong to the same domain, the Internet camera and the control terminal device must be manually reset for the IP address so that the Internet camera and the control terminal device can connect with each other. Consequently, it is very common that the Internet camera and the control terminal device often fail to connect because the Internet camera and the control terminal device cannot find the IP address of each other. Further, manual resetting is complicated and requires sufficient experience with network configuration. For common users, the process is both inconvenient and confusing.

Thus, it is desirable to devise a method of managing port DHCP server protocol addresses, which is able to send message in a priority manner so as to reduce the connection waiting time and provide convenient management of each port.

### SUMMARY OF THE INVENTION

The primary objective of the present invention is to provide a method of managing port DHCP server protocol addresses, through at least a port connecting to port DHCP server, and the port DHCP server being disposed with a port IP address allocation table. When the at least a port changes from a disconnection state to connection state, the port DHCP server will be given priority to receive the broadcast DHCP discovery message packet transmitted by the client from the port. The port DHCP server will rush to block the other DHCP server from issuing DHCP offer message packet (wherein “rush” implies that the port DHCP server responds earlier than the other DHCP servers) and search the port IP address allocation table for default IP address of the port. Then, the port DHCP server will give priority to respond to the client with a DHCP offer message packet including default IP address of the port so that the client can obtain the default IP address of the port rapidly. As such, the connection waiting time is shortened and the overall performance and application is improved.

The secondary objective of the present invention is to provide a method of managing port DHCP server protocol addresses, through at least a port connecting to port DHCP server, and the port DHCP server being disposed with a port IP address allocation table. When the at least a port is in connection state, after the port DHCP server receives the broadcast DHCP discovery message packet transmitted by the client, the port DHCP server will check the MAC address in the DHCP discovery message packet to determine whether the MAC address is the same as the MAC address originally allocated to the client. When the MAC address is the same as the MAC address originally allocated to the client, the port DHCP server will be given priority to respond to the client with a DHCP offer message packet including default IP address of the port. When the MAC address is different from the MAC address originally allocated to the client, the port DHCP server will use address resolution protocol (ARP) to determine whether the original client using the port MAC address has withdrawn. When the original client using the port MAC address has withdrawn, the port DHCP server will be given priority to search the port IP address allocation table for default IP address of the port and respond to the client with a DHCP offer message packet including default IP address of the port so that the client can obtain the default IP address of the port rapidly. As such, the connection waiting time is shortened and the overall performance and application is improved.

In order to achieve the foregoing objectives, the present invention provides a method of managing port DHCP server protocol addresses. The port DHCP server is connected to at least a port, the port DHCP server is disposed with a port IP address allocation table, and the port IP address allocation table includes default mapping between a port and IP address. The method includes the following steps: detecting a port: when at least a port changing from disconnection state to connection state, the client broadcasting DHCP discovery message packet from the port to search for IP address given by other DHCP server; rushing to respond: when the port DHCP server being given priority to receive DHCP discovery message packet, the port DHCP server rushing to block other DHCP server from issuing DHCP offer message packet, and searching the disposed port IP address allocation table for default IP address of the port, and the port DHCP server giving priority to respond a DHCP offer message packet to the client, and the DHCP offer message packet including the default IP address of the port; the client requesting: when the client receiving DHCP offer message packet, the client broadcasting a DHCP request message packet from the port to the port DHCP server and other DHCP server so that the other DHCP server being informed of the client having selected the default IP address provided by the port DHCP server; the port DHCP server acknowledging: when the port DHCP server receiving the DHCP request message packet broadcast by the client, the port DHCP server issuing a DHCP Ack message packet including the default IP address of the port and other configuration settings to the client so as to accomplish the address allocation.

### BRIEF DESCRIPTION OF THE DRAWINGS

The present invention can be fully understood from the following detailed description and preferred embodiment with reference to the accompanying drawings, in which:

FIG. 1 shows a schematic view of the message packet transmission according to the present invention;

FIG. 2 shows a schematic view of the structure of the present invention;

FIG. 3 shows a flowchart from a disconnection state entering a connection state according to the present invention; and

FIG. 4 shows a flowchart of the connection state according to the present invention.

### DETAILED DESCRIPTION OF THE PREFERRED EMBODIMENTS

With reference to the drawings and in particular to FIGS. 1-4, which show schematic views of a method of managing port DHCP server protocol addresses according to the present invention. The first embodiment of the present invention is that the port DHCP server 10 is connected to at least a port 20. The port DHCP server is disposed with a port IP address allocation table 30. The port IP address allocation table 30 includes default mapping between the port and IP address 31. The method includes the following steps: step S100: detecting a port: when at least a port 20 changing from disconnection state to connection state, the client 40 broadcasting DHCP discovery message packet 41 from the port 20 to search for IP address 52 given by other DHCP server 50; Step S110: rushing to respond: when the port DHCP server 10 being given priority to receive DHCP discovery message packet 41 broadcast from the port 20, the port DHCP server 10 rushing to block other DHCP serve 50 from issuing DHCP offer message packet 51, and searching the disposed port IP address allocation table 30 for default IP address 31 of the port, and the port DHCP server 10 giving priority to respond with a DHCP offer message packet 11 to the client 40, and the DHCP offer message packet 11 including the default IP address 31 of the port; step S120: the client 40 requesting: when the client 40 receiving DHCP offer message packet 11, the client 40 broadcasting a DHCP request message packet 42 from the port 20 to the port DHCP server 10 and other DHCP server 50 so that the other DHCP server 50 being informed of the client 40 having selected the default IP address 31 provided by the port DHCP server 10; step S130: the port DHCP server acknowledging: when the port DHCP server 10 receiving the DHCP request message packet 42 broadcast by the client 40, the port DHCP server 10 issuing a DHCP Ack message packet 12 including the default IP address 31 of the port and other configuration settings to the client 40 so as to accomplish the address allocation.

The second embodiment of the present invention provides a method of managing port DHCP server protocol addresses, wherein the port DHCP server 10 is connected to at least a port 20, and the port DHCP server 10 is disposed with a port IP address allocation table 30. The port IP address allocation table 30 includes default mapping between the port and IP address 31. The method includes the following steps: step S200: detecting a port: when at least a port 20 being in connection state, the client 40 broadcasting DHCP discovery message packet 41 from time to time to the port DHCP server 10 and other DHCP server 50; Step S210: determining address: after the port DHCP server 10 receiving the broadcast DHCP discovery message packet 41, the port DHCP server 10 checking the MAC address 411 in the DHCP discovery message packet 41 to determine whether the MAC address 411 being the same as the MAC address 411 originally allocated to the client 40; step S220: rushing to respond: when the MAC address 411 being the same as the MAC address 411 originally allocated to the client 40, the port DHCP server 10 being given priority to respond to the client 40 with a DHCP offer message packet 11 including default IP address 31 of the port 10; step S230: the client requesting: when the client 40 receiving DHCP offer message packet 11, the client 40 broadcasting a DHCP request message packet 42 from the port 20 to the port DHCP server 10 and other DHCP server 50 so that the other DHCP server 50 being informed of the client 40 having selected the default IP address 31 provided by the port DHCP server 10; step S240: the port DHCP server acknowledging: when the port DHCP server 10 receiving the DHCP request message packet 42 broadcast by the client 40, the port DHCP server 10 issuing a DHCP Ack message packet 12 including the default IP address 31 of the port and other configuration settings to the client 40 so as to accomplish the address allocation.

When, in step S210, the MAC address 411 is determined to be different from the MAC address 411 originally allocated to the client 40, a step S2110 (ARP determination) is executed wherein the port DHCP server 10 will use address resolution protocol (ARP) 13 to determine whether the original client 40 using the port MAC address 41 of the port 20 has withdrawn. When the original client 40 using the port MAC address 41 of the port 20 has withdrawn, the port DHCP server 10 will be given priority to search the port IP address allocation table 30 for default IP address 31 of the port 20 and respond to the client 40 with a DHCP offer message packet 11 including default IP address 31 of the port 20. In addition, the port DHCP server 10 further connects to a web server 60 and uses a common gateway interface (CGI) 61 to exchange messages. In addition to default IP address 31 of the port 20, the DHCP offer message packet 11 also includes the MAC address of the port 20, the subnet mask, the gateway, and so on protocol. The client 40 is device 43 further disposed with IP setting, and the device 43 with IP setting is disposed with a DHCP client 431 for transmitting message packets with the port DHCP server 10 or other DHCP server 50.

Referring to FIGS. 1-4, which show schematic views of the method of managing port DHCP server protocol addresses according to the present invention, the preferred embodiment of the present invention is to be applied to hub, switch hub, router, IP router or other similar devices (not shown). The above devices are disposed with a port DHCP server 10 and the port DHCP server 10 is connected to at least a port 20. The port DHCP server 10 comprises a port IP address allocation table 30 and the port IP address allocation table 30 predefines the default IP address 31 for the port (such as P00: 192.168.11.100-P23: 192.168.11.123) (as shown in FIG. 2). Therefore, when at least a port 20 is connected to the client 40, step 200 is performed for detecting port (as shown in FIG. 4): when at least a port 20 is in connection state, the client 40 will broadcasts DHCP discovery message packet 41 from time to time to the port DHCP server 10 and other DHCP server 50 (as shown in FIG. 1); wherein the client 40 is an equipment 43 (such as notebook PC, desktop PC, Internet camera, and so on) with IP setting, and the equipment 43 with IP setting is disposed with a DHCP client 431. Through the DHCP client 431, the equipment 43 with IP setting broadcasts from time to time to the port 20 and sends DHCP discovery message packet 41 from time to time to the port DHCP server 10 or other DHCP server 50. Therefore, when the client 40 issues DHCP discovery message packet 41, step S210 is executed next to determine the address (as shown in FIG. 4): when the port DHCP server 10 receives broadcast DHCP discovery message packet 41, the MAC address 411 in the DHCP discovery message packet 41 is also checked to determine whether the MAC address 411 in the DHCP discovery message packet 41 is the same as the MAC address 411 originally allocated to the client 40 (as shown in FIG. 1); and the port DHCP server 10 will receive the DHCP discovery message packet 41 transmitted from the port 20 and check the MAC address 411 in the received DHCP discovery message packet 41 to determine whether the MAC address 411 in the DHCP discovery message packet 41 is the same as the MAC address 411 of the IP address 31 originally allocated to the client 40. Therefore, when the port DHCP server 10 performs determination, the next step S220 is executed to rush to respond (as shown in FIG. 4): after determining that the MAC address 411 in the DHCP discovery message packet 41 is the same as the MAC address 411 originally allocated to the client 40, the port DHCP server 10 will give priority to respond to the client 40 with a DHCP offer message packet 11 including default IP address 31 (as shown in FIG. 1) to the client 40. In other words, when the port DHCP server 10 confirms that the MAC address 411 in the DHCP discovery message packet 41 received from the port 20 is the same as the MAC address 411 of the IP address 31 originally allocated to the client 40, the port DHCP server 10 will rush to respond to the client 40 with a DHCP offer message packet 11 to inform the client 40 that the connection to the port DHCP server 10 is correct; wherein, in addition to the default IP address 31 of the port, the DHCP offer message packet also includes MAC address of the port 20, subnet mask, gateway protocol, and so on, so that the client 40 can maintain connection. Therefore, when the client 40 receives the DHCP offer message packet 11 from the port DHCP server 10, the next step S230 is executed (as shown in FIG. 4): when the client 40 receives the DHCP offer message packet 11, the client 40 broadcasts a DHCP request message packet 42 from the port 20 to the port DHCP server 10 and other DHCP server 50 so that the other DHCP server 50 are informed of the client 40 having selected the default IP address 31 provided by the port DHCP server 10 (as shown in FIG. 1). In other words, after receiving the DHCP offer message packet 11, the client 40 will broadcast the DHCP request message packet 42 through the port 20 to the port DHCP server 10 and other DHCP server 50 so that the other DHCP server 50 are informed that the client 40 has already selected the default IP address 31 provided by the port DHCP server 10 for connection to connect the web server 60 through the port DHCP server 10 and exchange messages through the common gateway interface (CGI) 61 to shorten waiting time. Therefore, after the client 40 sends the DHCP request message packet 42, the next step S240 is executed (as shown in FIG. 4): when the port DHCP server 10 receives the DHCP request message packet 42 broadcast by the client 40, the port DHCP server 10 issues a DHCP Ack message packet 12 including the default IP address 31 of the port 20 and other configuration settings to the client 40 so as to accomplish the address allocation (as shown in FIG. 4). When the port DHCP server 10 receives the DHCP request message packet 42 broadcast by the client 40, the port DHCP server 10 issues a DHCP Ack message packet 12 including the default IP address 31 of the port 20 and other configuration settings to the client 40 so that the client 40 can continue using the original IP address 31 for connection.

In addition, when the step S210 of determining the address checks whether the MAC address 411 in the DHCP discovery message packet 41 is the MAC address 411 originally allocated to the client 40, the next step S2110 of ARP determination is executed (as shown in FIG. 4): the port DHCP server 10 will use ARP 13 to confirm whether the original client 40 using the MAC address 411 of the port 20 has withdrawn. When the original client 40 using the MAC address 411 of the port 20 has withdrawn, the port DHCP server 10 will give priority to searching for the default IP address 31 of the port 20 in the disposed port IP address allocation table 30, and propagate the DHCP offer message packet 11 including the default IP address 31 of the port 20 to the client 40 (as shown in FIG. 1). In other words, when the port DHCP server 10 determines that the MAC address 411 in the DHCP discovery message packet 41 issued by the client 40 is not the same as the original MAC address 411 allocated to the client 40, the port DHCP server 10 will use the ARP 13 to confirm whether the original client 40 using the MAC address 411 of the port 20 has withdrawn. When the original client 40 using the MAC address 411 of the port 20 has withdrawn, the port DHCP server 10 will send a DHCP Nack message packet to the client 40 and return to the non-allocated state, i.e., the state that the client entering from disconnection state to connection state. AT this point, when the at least a port 20 enters from the disconnection state to the connection state, all the steps must be start from the beginning, i.e., step S100 to detect the port (as shown in FIG. 3): when at least a port 20 enters from the disconnection state to the connection state, the client 40 will broadcast a DHCP discovery message packet 41 from the port 20 to search for the IP address 52 given by other DHCP server 50 (as shown in FIG. 1); the client 40 will re-start to broadcast the DHCP discovery message packet 41 from the port 20 to other DHCP server 50, including port DHCP server 10, requesting for providing IP address 52 for use. Therefore, after the client 40 sends the DHCP discovery message packet 41, the next step S110 of rushing to respond is executed (as shown in FIG. 3): when the port DHCP server 10 will be given priority to receive the DHCP discovery message packet 41, the port DHCP server 20 will rush to respond or block the DHCP offer message packet 51 from other DHCP server 50, and searches the disposed port IP address allocation table 30 for the default IP address 31 of the port. The port DHCP server 10 will also give priority to respond the DHCP offer message packet 11 including the default IP address 31 of the port to the client 40 (as shown in FIG. 1). After the port DHCP server 10 receives the DHCP discovery message packet 41 issued by the client 40, the port DHCP server 10 will rush to find the IP address 31 of the port in the port IP address allocation table 30 and respond with the first DHCP offer message packet 11 to the client 40 (wherein “rush” means the first to respond earlier than the other DHCP server 50. The DHCP offer message packet 11 includes the default IP address 31 of the port and the port DHCP server 10 can also block DHCP offer message packets 51 from the other DHCP server 50 when first receiving the DHCP discovery message packet so that the other DHCP server 50 cannot exchange message packets with the client 40 and the port DHCP server 10 becomes the first to respond with a DHCP offer message packet 11 to the client 40. Therefore, after the port DHCP server 10 sends the DHCP offer message packet 11 including the default IP address 31 of the port 20, the port DHCP server 10 executes the next step S120 of the client requesting (as shown in FIG. 3): when the client 40 receives DHCP offer message packet 11, the client 40 broadcasts a DHCP request message packet 42 from the port 20 to the port DHCP server 10 and other DHCP server 50 so that the other DHCP server 50 are informed of the client 40 having selected the default IP address 31 provided by the port DHCP server 10 (as shown in FIG. 3). In other words, when the client 40 receives DHCP offer message packet 11, wherein the DHCP offer message packet 11 also includes MAC address of the port 20, subnet mask, gateway protocol, and so on, in addition to the default IP address 31 of the port 20, the client 40 can change the settings of the DHCP client 431 based on the protocols in the received DHCP offer message packet 11 so that the client 40 can form a domain with the port DHCP server 10, and then the client 40 broadcasts a DHCP request message packet 42 from the port 20 to the port DHCP server 10 and other DHCP server 50 so that the other DHCP server 50 are informed of the client 40 having selected the default IP address 31 provided by the port DHCP server 10. Therefore, after the client 40 sends the DHCP request message packet 42, the next step S130 of the port DHCP server acknowledging is executed (as shown in FIG. 3): when the port DHCP server 10 receives the DHCP request message packet 42 broadcast by the client 40, the port DHCP server 10 issues a DHCP Ack message packet 12 including the default IP address 31 of the port 20 and other configuration settings to the client 40 so as to accomplish the address allocation (as shown in FIG. 1). In other words, when the port DHCP server 10 receives the DHCP request message packet 42 broadcast by the client 40, the port DHCP server 10 issues a DHCP Ack message packet 12 including the default IP address 31 of the port 20 and other configuration settings to the client 40 so that the client 40 can continue to use the original IP address 31 for connection to connect the web server 60 through the port DHCP server 10 and exchange messages through the common gateway interface (CGI) 61 to shorten waiting time. As such, the method of managing port DHCP server protocol addresses of the present invention enables the port DHCP server 10, whether in connection state or disconnection state, can give priority to respond to the client 40 and the client 40 can be given priority to use the default IP address 31 provided by the port DHCP server 10, instead of waiting for floating IP address 52 provided by remote other DHCP server 50. In addition, when the hardware connected to the port 20 is replaced or reset, the hardware can automatically obtain the default IP address 31 of the port 20. When the port 20 is connected to more than one equipment with IP setting, the present invention allows the first device to obtain the default IP address 31 of the port 20 and the other devices will automatically obtain floating IP address 52 provided by remote other DHCP server 50 so as to shorten the waiting time and provide convenient management of the connections of each port 20.

Based on the above detailed description, those skilled in the art may appreciate that the present invention can achieve the above discussed objectives. However, it is noted that the above description is made only to a preferred embodiment of the present invention and is not intending to limit the true scope where the present invention may be put into practice. Thus, simple and equivalent variations and modifications made on the disclosure of the specification and the attached claims are all considered within the scope of the present invention.

What is claimed is:

1. A method of managing port DHCP server protocol addresses, the port DHCP server being connected to at least a port, the port DHCP server being disposed with a port IP address allocation table, and the port IP address allocation table comprising default mapping between a port and IP address, the method comprising the steps of:
detecting a port: when at least a port changing from disconnection state to connection state, the client broadcasting DHCP discovery message packet from the port to search for IP address given by other DHCP server;
rushing to respond: when the port DHCP server being given priority to receive DHCP discovery message packet, the port DHCP server rushing to block other DHCP server from issuing DHCP offer message packet, and searching the disposed port IP address allocation table for default IP address of the port, and the port DHCP server giving priority to respond a DHCP offer message packet to the client, and the DHCP offer message packet including the default IP address of the port;
the client requesting: when the client receiving DHCP offer message packet, the client broadcasting a DHCP request message packet from the port to the port DHCP server and other DHCP server so that the other DHCP server being informed of the client having selected the default IP address provided by the port DHCP server, and
the port DHCP server acknowledging: when the port DHCP server receiving the DHCP request message packet broadcast by the client, the port DHCP server issuing a DHCP Ack message packet including the default IP address of the port and other configuration settings to the client so as to accomplish the address allocation.

2. The method of managing port DHCP server protocol addresses according to claim 1, wherein the port DHCP server is further connected to a web server and exchanges messages through common gateway interface (CGI).

3. The method of managing port DHCP server protocol addresses according to claim 1, wherein the DHCP offer message packet further comprises MAC address, subnet mask, and gateway protocols, in addition to a default IP address of the port.

4. The method of managing port DHCP server protocol addresses according to claim 1, wherein the client is an equipment with IP setting, and the equipment with IP setting is further disposed with a DHCP client and is able to exchange message packets with the port DHCP server or other DHCP server.

5. A method of managing port DHCP server protocol addresses, the port DHCP server being connected to at least a port, and the port DHCP server being disposed with a port IP address allocation table, the port IP address allocation table comprising default mapping between the port and IP address; the method comprising the steps of:
detecting a port: when the at least a port being in connection state, the client broadcasting a DHCP discovery message packet from time to time to the port DHCP server and other DHCP server;
determining address: after the port DHCP server receiving the broadcast DHCP discovery message packet, the port DHCP server 10 checking a MAC address in the DHCP discovery message packet to determine whether the MAC address being the same as a MAC address originally allocated to the client;
rushing to respond: when the MAC address being the same as the original MAC address allocated to the client, the port DHCP server being given priority to respond to the client with a DHCP offer message packet including default IP address of the port;
the client requesting: when the client receiving DHCP offer message packet, the client broadcasting a DHCP request message packet from the port to the port DHCP server and other DHCP server so that the other DHCP server being informed of the client having selected a default IP address provided by the port DHCP server; and
the port DHCP server acknowledging: when the port DHCP server receiving the DHCP request message packet broadcast by the client, the port DHCP server issuing a DHCP Ack message packet including the default IP address of the port and other configuration settings to the client so as to accomplish the address allocation.

6. The method of managing port DHCP server protocol addresses according to claim 5, wherein when the MAC address is determined to be different from the original MAC address allocated to the client, a step of ARP determination is executed: the port DHCP server using an address resolution protocol (ARP) to determine whether the original client using the port MAC address of the port having withdrawn; and when the original client using the port MAC address of the port having withdrawn, the port DHCP server being given priority to search the port IP address allocation table for the default IP address of the port respond to the client with a DHCP offer message packet including the default IP address of the port.

7. The method of managing port DHCP server protocol addresses according to claim 5, wherein the port DHCP server is further connected to a web server and exchanges messages through common gateway interface (CGI).

8. The method of managing port DHCP server protocol addresses according to claim 5, wherein the DHCP offer message packet further comprises MAC address, subnet mask, and gateway protocols, in addition to a default IP address of the port.

9. The method of managing port DHCP server protocol addresses according to claim 5, wherein the client is an equipment with IP setting, and the equipment with IP setting is further disposed with a DHCP client and is able to exchange message packets with the port DHCP server or other DHCP server.
